(19) United States
(12) Patent Application Publication
(10) Pub. No.: US 2009/0297192 A1
(43) Pub. Date: Dec. 3, 2009

(54) Developing device, image forming apparatus and method of forming image

(75) Inventor: Koichi Matsuzaki, Tokyo (JP)

Correspondence Address: Kubotera & Associates, LLC, 200 Daingerfield Rd, Suite 202, Alexandria, VA, 22314, US

(73) Assignee: Oki Data Corporation

(21) Appl. No.: 12/382,901

(22) Filed: Mar. 26, 2009

(30) Foreign Application Priority Data
May 28, 2008 (JP) 2008-138839

(51) Int. Cl. G03G 15/08

(52) U.S. Cl. 399/55

(57) ABSTRACT

An image forming apparatus includes an image supporting member for supporting a static latent image; and a developer supporting member for developing the static latent image formed on the image supporting member using developer. It is configured to supply developer to the developer supporting member so that a ratio of a maximum amount of the developer on the image supporting member per unit area with respect to an amount of the developer on the developer supporting member per unit area does not exceed 0.60.

### BACKGROUND OF THE INVENTION AND RELATED ART STATEMENT

The present invention relates to a developing device, an image forming apparatus such as an electro-photography printer.

In a conventional electro-photography printer, an electro-photography process is performed as follows. In a charging process, an optical conductive insulation layer of a photosensitive drum is charged. In an exposing process, the optical conductive insulation layer is exposed, so that charges on an exposed portion are removed, thereby forming a static latent image on the photosensitive drum. In a developing process, a developing roller attaches developer (toner) containing at least colorant to the photosensitive drum to visualize the static latent image. In a transferring process, an image thus visualized is transferred to a sheet. In a fixing process, the image thus visualized is fixed to the sheet through heat and pressure.

Patent Reference has disclosed a conventional image forming apparatus. In the conventional image forming apparatus, a developing roller rotates at various rotational speeds according to a print dot density to adjust an amount of toner on a photosensitive drum, thereby obtaining a constant print density. According to Patent Reference, when an image with a high print dot density is formed, an amount of toner to be supplied tends to be insufficient if a developing roller supplies a constant amount of toner, thereby obtaining only an image with a low print dot density. To this end, in Patent Reference, it is configured such that the developing roller rotates at various rotational speeds according to a print dot density of print data to adjust an amount of toner to be supplied.

Patent Reference: Japanese Patent Publication No. 06-087236

### SUMMARY OF THE INVENTION

According to a first aspect of the present invention, an image forming apparatus includes an image supporting member for supporting a static latent image; and a developer supporting member for developing the static latent image formed on the image supporting member using developer.

Further, according to the first aspect of the present invention, it is configured to supply developer to the developer supporting member so that a ratio of a maximum amount of the developer on the image supporting member per unit area with respect to an amount of the developer on the developer supporting member per unit area does not exceed 0.60.

According to a second embodiment of the present invention, a method of forming an image includes the steps of forming a static latent image on an image supporting member; supplying developer to a developer supporting member; and developing the static latent image on the image supporting member using the developer.

Further, according to the second aspect of the present invention, in the step of supplying the developer to the developer supporting member, the developer is supplied so that a ratio of a maximum amount of the developer on the image supporting member per unit area with respect to an amount of the developer on the developer supporting member per unit area does not exceed 0.60.

In the image forming apparatus according to the present invention, even when a print dot density of print data is high, it is possible to prevent the print dot density from fluctuating without decreasing a through put, thereby maintaining the print dot density at a constant level.

### BRIEF DESCRIPTION OF THE DRAWINGS

FIG. 1 is a schematic view showing a developing device according to a first embodiment of the present invention;

FIG. 2 is a schematic view showing an image forming apparatus according to the first embodiment of the present invention;

FIG. 3 is a block diagram showing the image forming apparatus according to the first embodiment of the present invention;

FIGS. 4(a) to 4(b) are views showing an evaluation pattern;

FIG. 5 is a view showing Table of results of an evaluation;

FIGS. 6(a) to 6(c) are views showing standards of the evaluation;

FIGS. 7(a) to 7(c) are schematic enlarged sectional views showing a surface layer of a developing roller according to the first embodiment of the present invention; and

FIG. 8 is a block diagram showing the image forming apparatus according to a second embodiment of the present invention.

### DETAILED DESCRIPTION OF THE PREFERRED EMBODIMENTS

Hereunder, embodiments of the present invention will be described in detail with reference to the accompanying drawings.

### First Embodiment

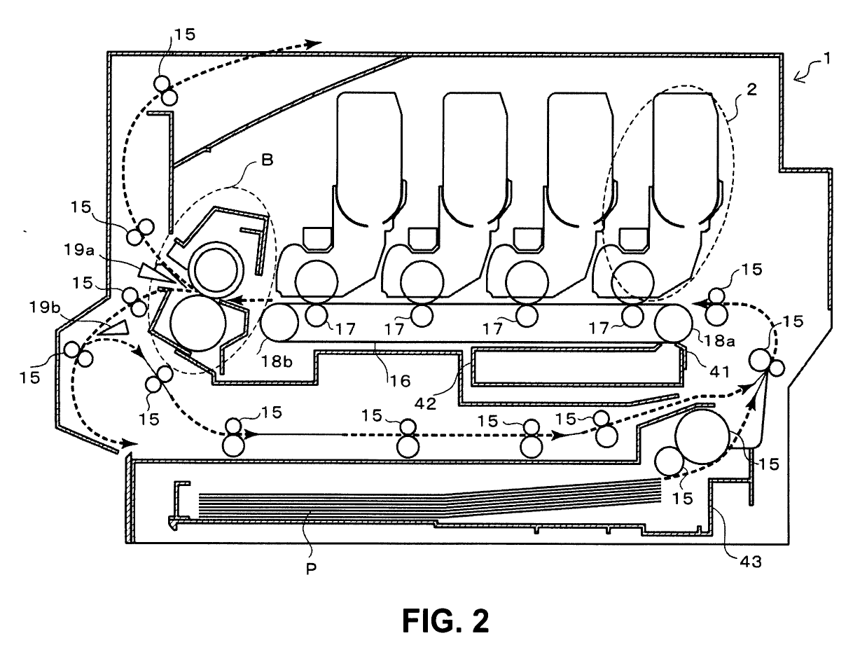

A first embodiment of the present invention will be explained. FIG. 2 is a schematic view showing an image forming apparatus or a printer 1 according to the first embodiment of the present invention.

As shown in FIG. 2, the printer 1 includes four developing devices 2 for black toner, yellow toner, magenta toner, and cyan toner. The developing devices 2 have an identical configuration except developer to be used. The printer 1 further includes a recording sheet transport roller 15 for transporting a recording sheet P as a print medium; a transfer belt 16; a transfer roller 17; an idle roller 18a and a drive roller 18b for driving the transfer belt 16 to rotate; and recording sheet transport guides 19a and 19b disposed to be movable. The printer 1 further includes a transfer belt cleaning blade 41; a waste developer tank 42; and a recording sheet cassette 43. A fixing device B is provided for fixing developer to the recording sheet P through heat and pressure.

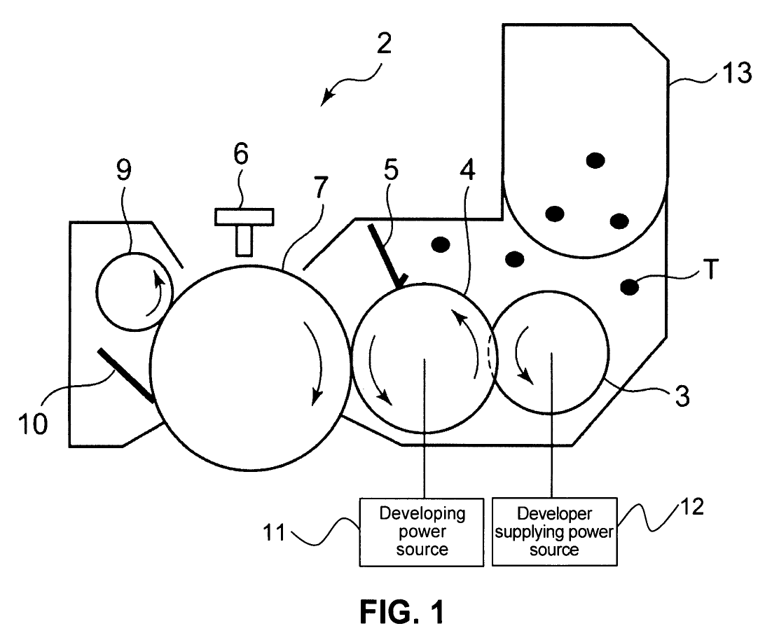

FIG. 1 is a schematic view showing the developing device 2 according to the first embodiment of the present invention. As shown in FIG. 1, the developing device 2 of the printer 1 of an electro-photography type includes a developing roller 4 as a developer supporting member; a sponge roller 3 as a developer supplying member; a developing blade 5 as a thin layer forming member; a photosensitive drum 7 for forming a static latent image on a surface layer thereof; an LED head 6 for exposing the photosensitive drum 7 to form the static latent image thereon; a charging roller 9 for charging the photosensitive drum 7; and a cleaning blade 10 for scraping off toner T remaining on the photosensitive drum 7. The toner T drops from a toner cartridge 13 and is situated around the sponge roller 3. The photosensitive drum 7 contacts with the developing roller 4, the charging roller 9, and the cleaning blade 10. Further, the developing roller 4 contacts with the sponge roller 3 and the developing blade 5.

In the embodiment, the developing roller 4 is formed of a steel core plated with nickel; an elastic layer formed of a urethane rubber and disposed around the steel core; and a surface layer formed of isocyanate and disposed on a surface of the elastic layer. The developing roller 4 has an outer diameter of 19.6 mm.

In the embodiment, the sponge roller 3 is formed of a metal core, and a silicone foamed rubber disposed on the metal core and having a cell with a diameter of 300 μm to 500 μm. The sponge roller 3 has an outer diameter of 15.5 mm at a center portion thereof and 14.8 mm at an end portion thereof.

In the embodiment, the developing blade 5 is formed of two laminated stainless steel plates (SUS304B-TA) having a thickness of 0.08 mm and bent with a curvature of 0.275 mm. As shown in FIG. 1, the developing blade 5 is arranged such that a short side thereof thus bent is situated at an upstream side and a long side thereof is situated at a downstream side in a rotational direction of the developing roller 4. Further, the developing blade 5 is arranged to contact with the developing roller 4 with a specific linear pressure (about 40 to 70 gf/cm). The photosensitive drum 7 includes an aluminum tube and a surface layer formed of an organic compound, and has an outer diameter of 29.95 mm.

In the embodiment, each roller or each drum is fixed to a gear for transmitting drive. More specifically, a drum gear (not shown) is fixed to the photosensitive drum 7; a developing gear (not shown) is fixed to the developing roller 4; a sponge gear (not shown) is fixed to the sponge roller 3; a charging gear (not shown) is fixed to the charging roller 9; and an idle gear is disposed between the developing gear and the sponge gear. A print pitch (a DV pitch) on the developing roller 4 is set to 47.5 mm according to an arrangement and diameters of the gears.

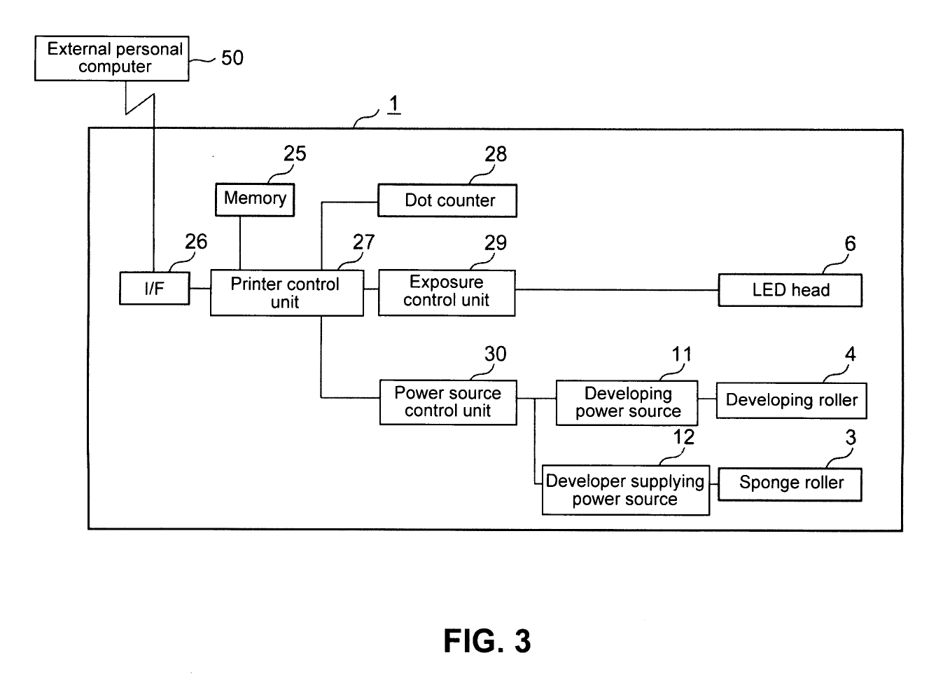

FIG. 3 is a block diagram showing the image forming apparatus according to the first embodiment of the present invention. Components the same as those in FIG. 1 are designated with the same reference numerals. As shown in FIG. 3, the printer 1 includes an interface (I/F) 26 as a connection member for connecting to an external personal computer 50; a printer control unit 27; and a memory 25 for deploying image data. Further, the printer 1 includes a dot counter 28 as an image density measurement unit; an exposure control unit 29 for controlling the LED head 6; and a power source control unit 30. The printer control unit 27 controls the dot counter 28, the exposure control unit 29, and the power source control unit 30.

In the embodiment, the printer 1 further includes a developing power source 11 for supplying a voltage (developing voltage DB) to the developing roller 4, and a developer supplying power source 12 for supplying a voltage (sponge voltage SB) to the sponge roller 3. The power source control unit 30 controls the developing power source 11 and the developer supplying power source 12. The sponge voltage SB is controlled according to a difference thereof with respect to the developing voltage DB, and an absolute value of the difference (SB−DB) is represented with DS. A power source (not shown) is connected to the charging roller 9. The power source disposed in the printer 1 includes a general high voltage power source of an electro-photography printer.

An operation of the printer 1 shown in FIG. 2 will be explained next. When the printer control unit 27 sends a print instruction, a motor (not shown) disposed in the printer 1 starts rotating to transmit drive to the drum gear through several gears (not shown), thereby rotating the photosensitive drum 7. Further, drive is transmitted from the drum gear to the developing gear, thereby rotating the developing roller 4. Similarly, drive is transmitted from the developing gear to the sponge gear through the idle gear, thereby rotating the sponge roller 3. Further, drive is transmitted from the drum gear to the charge gear, thereby rotating the charging roller 9.

In the developing process, each roller and the drum rotate in arrow directions shown in FIG. 1, respectively. The motor (not shown) disposed in the printer 1 rotates to transmit drive to the components in the transfer process and the fixing process as well.

In the embodiment, when the motor starts rotating, the power sources disposed in the printer 1 apply specific voltages to the components in the developing process, the transfer process, and the fixing process. In FIG. 1, only the developing power source 11 and the developer supplying power source 12 are shown.

When the voltage is applied to the charging roller 9, the surface layer of the photosensitive drum 7 is uniformly charged while the charging roller 9 is rotating. When a portion of the photosensitive drum 7 thus charged reaches under the LED head 6, the LED head 6 emits light according to an image to be printed sent to the exposure control unit 29 controlled with the printer control unit 27, thereby forming the static latent image on the photosensitive drum 7. When a portion of the photosensitive drum 7 with the static latent image formed thereon reaches the developing roller 4, the toner T formed in a thin layer on the developing roller 4 with the developing blade 5 is attached to the photosensitive drum 7 through a potential difference between the static latent image on the photosensitive drum 7 and the developing roller 4.

In the transfer process, the toner T is transferred to the print medium, and in the fixing process, the toner T is fixed to the print medium through heat and pressure. The cleaning blade 10 scrapes off the toner T not transferred and remaining on the photosensitive drum 7. After the printing operation, the toner T is collected in the waste developer tank 42 according to a specific sequence controlled with the printer control unit 27.

An evaluation of the printer 1 will be explained next. An experiment was conducted for evaluating the printer 1 according to the embodiment of the present invention.

In the experiment, MICROLINE 9600PS (a product of OKI DATA Corporation) was used as the printer 1, in which the developing roller 4 rotated at a linear speed of 213.36 mm/sec. at an outermost circumference thereof, and the photosensitive drum 7 rotated at a linear speed ratio of 0.787 at an outermost circumference thereof relative to that of the developing roller 4. Further, the toner T, the developing roller 4, the developing voltage DB, and the absolute value of the difference DS were changed. An evaluation pattern was printed in one color to evaluate a blurred image, a DV afterimage, and stain.

In the experiment, four developing rollers α to δ were prepared using various files for polishing a surface thereof. Accordingly, a developing roller α had a surface roughness (ten-point average) Rz of 2 μm; a developing roller β had a surface roughness Rz of 5 μm; a developing roller γ had a surface roughness Rz of 10 μm; and a developing roller δ had a surface roughness Rz of 15 μm. The surface roughness Rz of the roller was measured according to JIS B0601-1994 using SEF3500K (a product of Kosaka Laboratory Ltd.) at three locations thereof, i.e., a center and both ends thereof, under conditions such as a contact needle tip radius of 2 μm; a contact needle pressure of 0.7 mN; a test range of 2.5 mm; a contact needle speed of 0.1 mm/s, and a cut-off of 2.5 mm.

In the experiment, toner was prepared with the following method (emulsion polymerization method). In the emulsion polymerization method, styrene, acrylic acid, and methyl-methacrylic acid were reacted in an aqueous solution to obtain a styrene-acrylic co-polymer as a primary particle. Carbon black was used as a coloring agent for black toner; pigment yellow 74 was used as a coloring agent for yellow toner; pigment red 238 was used as a coloring agent for magenta toner; and pigment blue 15:3 was used as a coloring agent for cyan toner. A higher fatty acid ester type wax such as stearate steallyl was used as wax.

In the next step, the ingredients described above were mixed to obtain toner particles (base toner). Then, 100 weight parts of the base toner; 0.7 weight parts of hydrophobic silica R972 (a product of NIPPON AEROSIL Co., Ltd.); 1.0 weight parts of colloidal silica having a particle size between 100 nm and 200 nm; and 0.10 weight parts of titanium oxide as a conductive fine powder were mixed in a Henschel mixer (a product of Mitsui Mining Co., Ltd.), thereby obtaining toner A after screening. Similarly, toner B was obtained using 0.25 weight parts of titanium oxide; toner C was obtained using 0.45 weight parts of titanium oxide; toner D was obtained using 0.60 weight parts of titanium oxide.

In the experiment, after the toner A to D was mixed with a non-coated ferrite carrier F150 (a product of Powdertech Co., Ltd.) for thirty minutes, a charge amount of the toner A to D was measured with a blow-off charge tester TB-200 (a product of KYOCERA Chemical Corporation). It was found that the toner A had a charge amount of −65 μC/g; the toner B had a charge amount of −50 μC/g; the toner C had a charge amount of −30 μC/g; and the toner D had a charge amount of −15 μC/g.

In the experiment, the base toner was mixed with tine powder of a material such as silica, alumina, titanium oxide, barium titanate, magnesium titanate, calcium titanate, strontium titanate, zinc oxide, quartz sand, clay, mica, wollastonite, diatomaceous earth, chromium oxide, cerium oxide, red iron oxide, antimony torioxide, magnesium oxide, zirconium oxide, barium sulfate, barium carbonate, calcium carbonate, silicon carbide, and silicon nitride.

In the experiment, the silica fine powder had a silicone bond (Si—O—Si), and may be produced with a dry method or a wet method. A material of the silica fine powder includes silica dioxide anhydride, aluminum silicate, sodium silicate, potassium silicate, magnesium silicate, and zinc silicate. Further, the silica fine power may be coated with a silane-type coupling agent, a titanium-type coupling agent, silicone oil, and silicon oil having an amine side group.

In the experiment, samples 1 to 16 and comparative samples 1 to 8 were prepared. More specifically, for example, in comparative sample 1, the toner A and the developing roller α were used, and the developing voltage DB was set at −300 V and the absolute value of the difference DS was set at 200 V. In comparative sample 2, the toner A and the developing roller β were used, and the developing voltage DB was set at −100 V and the absolute value of the difference DS was set at 150 V.

Similarly, in samples 1 to 4 and comparative sample 3, the toner B and the developing roller β were used, and the developing voltage DB was change from −100 V to −300 V and the absolute value of the difference DS was changed from 150 V to 200 V. In samples 5 to 8 and comparative sample 4, the toner B and the developing roller γ were used, and the developing voltage DB was change from −100 V to −300 V and the absolute value of the difference DS was changed from 150 V to 200 V. In samples 9 to 12 and comparative sample 5, the toner C and the developing roller β were used, and the developing voltage DB was change from −100 V to −300 V and the absolute value of the difference DS was changed from 150 V to 200 V.

Further, in samples 13 to 16 and comparative sample 6, the toner C and the developing roller γ were used, and the developing voltage DB was change from −100 V to −300 V and the absolute value of the difference DS was changed from 150 V to 200 V. In comparative sample 7, the toner C and the developing roller δ were used, and the developing voltage DB was set at −100 V and the absolute value of the difference DS was set at 200 V. In comparative sample 8, the toner D and the developing roller δ were used, and the developing voltage DB was set at −300 V and the absolute value of the difference DS was set at 200 V.

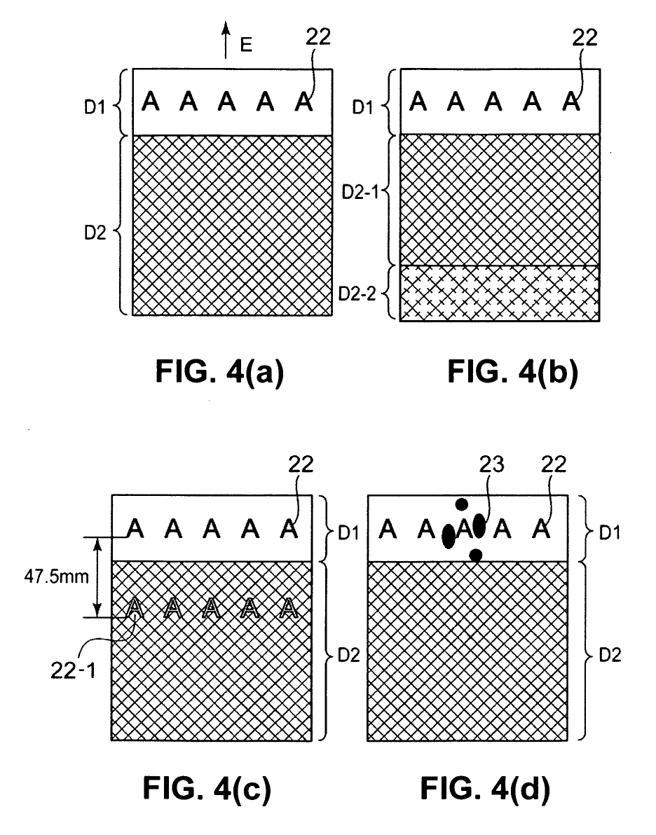

FIGS. 4(a) to 4(b) are views showing the evaluation pattern. The evaluation pattern used in the experiment was printed on an A3 sheet (in a longitudinal direction), and had a front portion D1 and a rear portion D2 in a printing direction E. A plurality of bold solid characters 22 was printed in the front portion D, and a solid image (a density of 100%, and represented as a hatched portion in the drawings) was printed in the rear portion D2.

FIG. 4(b) is a view showing the evaluation pattern with the blurred image. In general, when the sponge roller 3 supplies an insufficient amount of toner to the developing roller 4 relative to an image density, a rear portion tends to have the image density lower than that of a front portion, thereby causing the blurred image as shown in FIG. 4(b). The blurred image tends to occur more frequently when the print dot density is high. In FIG. 4(b), a portion D2-1 has the image density similar to that of the rear portion D2, and a portion D2-2 has the image density lower than that of the rear portion D2 (represented with light hatching).

FIG. 4(c) is a view showing the evaluation pattern with the DV afterimage. The DV afterimage occurs when there is a difference in potentials between a toner layer on the developing roller 4 in a portion where toner consumed in the front portion (consumed for printing the solid bold characters 22) is supplied and a portion where toner is not supplied. When the difference increases, the DV afterimage becomes more evident. Further, the DV afterimage occurs depending on the potential of the toner layer on the developing roller 4, so that the DV afterimage appears with the DV pitch (47.5 mm).

FIG. 4(d) is a view showing the evaluation pattern with the stain, in which black spots 23 of the toner T are formed (the black spots 23 in the rear portion D2 are omitted; in an actual case, the black spots 23 are formed in the rear portion D2). The stain occurs when the potential of the toner layer on the developing roller 4 becomes too high, and the toner T moves from the developing roller 4 to the photosensitive drum 7 regardless of the static latent image on the photosensitive drum 7.

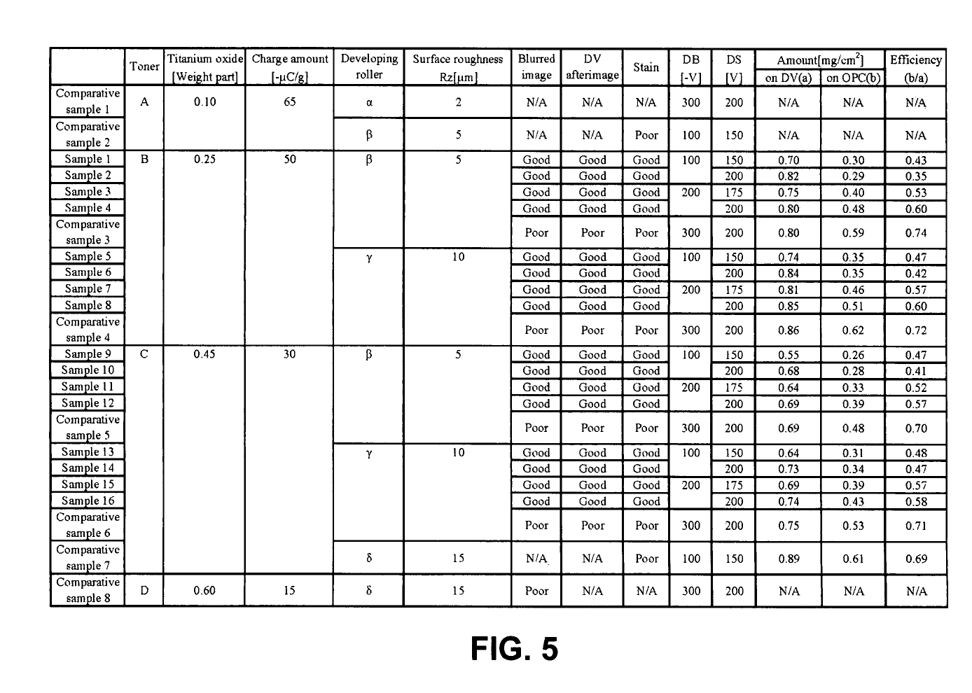

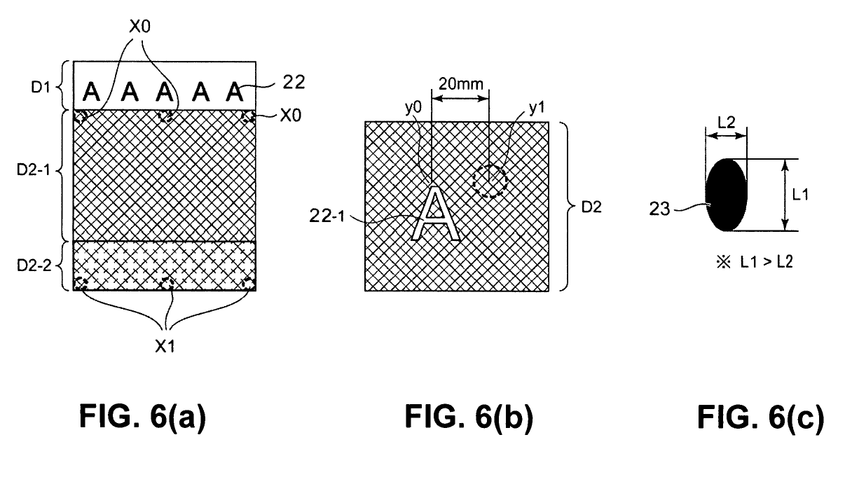

FIG. 5 is a view showing Table of results of the evaluation. FIGS. 6(a) to 6(c) are views showing standards of the evaluation.

In evaluating the blurred image, as shown in FIG. 6(a), image densities were measured at three locations, i.e., a center portion and both end portions, of the solid image printed in the portion D2-1 adjacent to the portion D-1 in which the bold solid characters 22 were printed. Then, an average value (a front end image density x0) of the image densities at the three locations was calculated. Similarly, image densities were measured at three locations of the solid image printed in the portion D2-1, and an average value (a rear end image density x1) of the image densities was calculated. Afterward, a difference between the front end image density x0 and the rear end image density x1 (x0−x1) was obtained. When the difference (x0−x1) was less than 0.30, the result was determined to be good. When the difference (x0−x1) was greater than 0.30, the result was determined to be poor. Note that the image density was measured with X-Rite 528 (a product of X-Rite Corporation).

In evaluating the DV afterimage, as shown in FIG. 6(b), an image density (a top portion image density y0) was measured at a location where a top portion of an afterimage of the bold solid character 22 was expected to be formed. Then, an image density (y1) was measured at a location away from the location of the top portion by 20 mm to the right side. Afterward, an average value of a difference between the top portion image density y0 and the image density y1 was calculated. When the difference was less than 0.20, the result was determined to be good. When the difference was greater than 0.20, the result was determined to be poor.

In evaluating the stain, as shown in FIG. 6(c), a maximum length (L1) of the black spot 23 with a irregular shape on a white area was measured. When the maximum length L1 was less than 0.30 mm, the result was determined to be good. When the maximum length L1 was greater than 0.30 mm, the result was determined to be poor. When data was not available due to a trouble and the likes, the result was indicated with “NA”.

In Table shown in FIG. 5, an amount (mg/cm²) “on DV” represents an amount of toner on the developing roller 4, and an amount (mg/cm²) “on OPC” represents an amount of toner on the photosensitive drum 7. More specifically, the amount “on DV” was measured as an amount (a) of toner on the developing roller 4 per unit area when the printing operation was performed on a white sheet. The amount “on OPC” was measured as an amount (b) of toner on the photosensitive drum 7 per unit area when the solid image (having a density of 100%) was printed. Further, a developing efficiency (b/a) was defined as the amount (b) of toner on the photosensitive drum 7 divided by the amount (a) of toner on the developing roller 4.

Accordingly, the developing efficiency (b/a) is an indicator representing an amount of the toner (a) on the developing roller 4 is transferred (developed) to become the toner (b) on the photosensitive drum 7 when the solid image is developed. For example, in sample 1 shown in Table, 0.70 mg/cm² of the toner on the developing roller 4 was developed to become 0.30 mg/cm² of the toner on the photosensitive drum 7 when the solid image was printed. In this case, the developing efficiency (b/a) was 0.43.

In comparative sample 1, it was difficult to obtain a sufficient image density (a target of the image density was 1.30 or greater), thereby not measuring further data in detail. In comparative sample 1, the developing roller α did not have a sufficient surface roughness, so that only a small amount of toner was on the developing roller α. In the electro-photography printer, when a charge amount of the toner increases, or the developing voltage DB and the absolute value of the difference DS increase, the image density tends to increase. However, when the developing roller α was used, it was difficult to obtain a sufficient image density even though the toner A with the largest charge amount was used at the maximum developing voltage and the maximum absolute value of the difference. Accordingly, the developing roller α was used only in comparative sample 1.

In comparative sample 2, the stain occurred, thereby omitting further evaluation. In comparative sample 2, the charge amount of the toner A was considered to be too high. When the surface roughness of the developing roller increases, or the developing voltage DB and the absolute value of the difference DS increase, the stain tends to occur. When the toner A was used, the stain occurred even though the maximum developing voltage and the maximum absolute value of the difference were used. Accordingly, the toner A was used only in comparative sample 2.

As shown in Table in FIG. 5, in samples 1 to 4, a good image was obtained without the blurred image, the DV afterimage, or the stain. In comparative sample 3, the blurred image, the DV afterimage, and the stain occurred. In samples 5 to 8, a good image was obtained without the blurred image, the DV afterimage, or the stain. In comparative sample 4, the blurred image, the DV afterimage, and the stain occurred. In samples 9 to 12, a good image was obtained without the blurred image, the DV afterimage, or the stain. In comparative sample 5, the blurred image, the DV afterimage, and the stain occurred. In samples 13 to 16, a good image was obtained without the blurred image, the DV afterimage, or the stain. In comparative sample 6, the blurred image, the DV afterimage, and the stain occurred.

Further, in comparative sample 7, the stain occurred. In comparative sample 7, the surface roughness of the developing roller δ was considered to be too high. Accordingly, the developing roller δ was not used in the experiment using the toner B. In comparative sample 8, the blurred image occurred. In comparative sample 8, the charge amount of the toner D was considered to be too low. Accordingly, the toner D was used only in comparative sample 8. The results described above were common in all colors, i.e., black, yellow, magenta, and cyan.

As described above, when the developing efficiency was less than 0.60 in samples 1 to 16, it was possible to form the good image without the blurred image, the DV afterimage, or the stain. Accordingly, when it is configured so that the developing efficiency is less than 0.60, it is possible to obtain a good image without lowering the through put.

In the embodiment, it is considered that the toner tends to be stocked on the developing roller 4 when the developing roller 4 rotates next time upon performing the printing operation to a greater extent as a ratio of the toner on the developing roller 4 consumed when the solid image is printed.

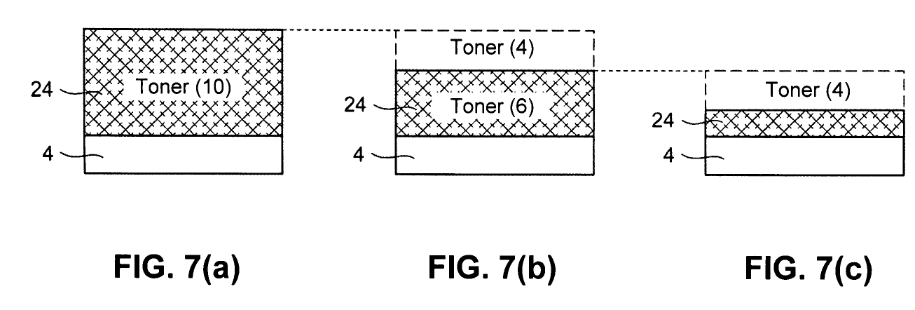

FIGS. 7(a) to 7(c) are schematic enlarged sectional views showing the surface layer of the developing roller 4, on which the toner layer is formed, according to the first embodiment of the present invention.

As shown in FIG. 7(a), it is assumed that an amount of the toner on the developing roller 4 is 10 before the printing operation is performed. When the solid image is printed, a consumed amount of the toner is, for example, 4, as shown in FIG. 7(b). In this case, the developing efficiency becomes 0.40. Accordingly, a remaining amount of the toner on the developing roller 4 becomes 6 as shown in FIG. 7(b) after the toner on the developing roller 4 is consumed according to one rotation of the developing roller 4. As a result, even though no toner is supplied from the sponge roller 3, it is possible to form the solid images corresponding to two rotations of the developing roller 4 as shown in FIG. 7(c).

In the embodiment, the lower limit of the developing efficiency is 0.35 according to Table shown in FIG. 5. With technological advancement in the future, it may be possible to obtain a sufficient image density using developer formed of only a coloring agent. In this case, the developing efficiency approaches to near zero.

### Second Embodiment

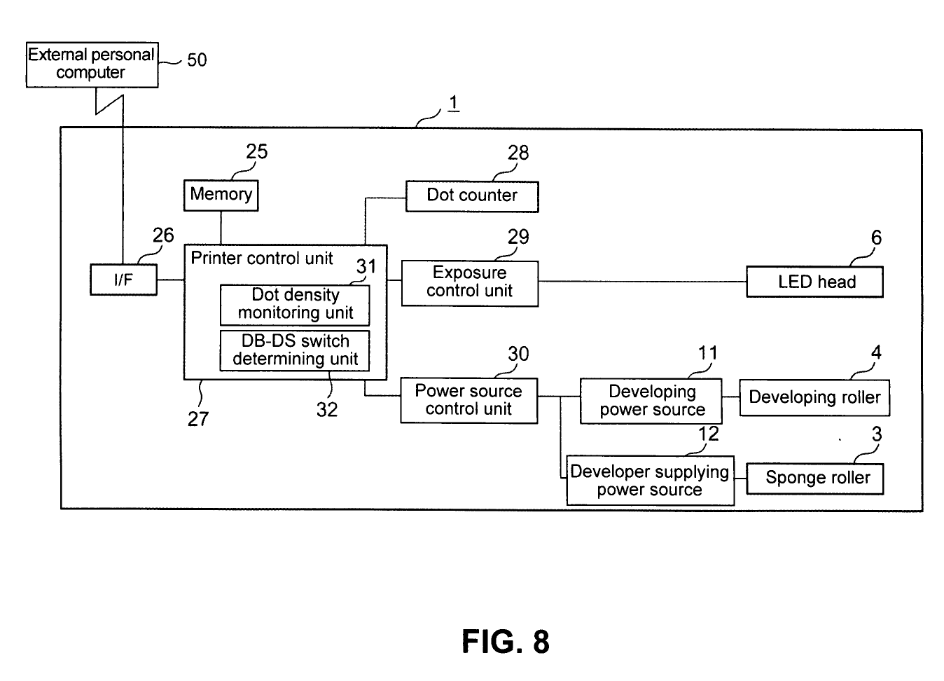

A second embodiment of the present invention will be described next. In the second embodiment, the printer 1 and the developing device 2 have configurations similar to those in the first embodiment. FIG. 8 is a block diagram showing the image forming apparatus or the printer 1 according to the second embodiment of the present invention. In the second embodiment, different from the first embodiment, the printer 1 includes a dot density monitoring unit 31 and a DB-DS switch determining unit 32.

As shown in FIG. 8, the printer 1 includes the interface (I/F) 26 as the connection member for connecting to the external personal computer 50; the printer control unit 27; and the memory 25 for deploying image data. Further, the printer 1 includes the dot counter 28 as the image density measurement unit; the exposure control unit 29 for controlling the LED head 6; and the power source control unit 30. The printer control unit 27 controls the dot counter 28, the exposure control unit 29, and the power source control unit 30. Further, the printer control unit 27 includes the dot density monitoring unit 31 for monitoring the dot density measured with the dot counter 28, and the DB-DS switch determining unit 32 for determining outputs of the developing voltage DB and the absolute value of the difference DS according to the monitoring of the dot density monitoring unit 31.

In the embodiment, the printer 1 further includes the developing power source 11 for supplying the developing voltage DB to the developing roller 4, and the developer supplying power source 12 for supplying the sponge voltage SB to the sponge roller 3. The power source control unit 30 controls the developing power source 11 and the developer supplying power source 12. The sponge voltage SB is controlled according to the difference thereof with respect to the developing voltage DB, and the absolute value of the difference (SB−DB) is represented with DS.

An operation of the printer 1 will be explained next. In the second embodiment, the developing voltage DB and the absolute value of the difference DS are changed according to image data. When the personal computer 50 sends the image data to the printer control unit 27 through the interface 26, the printer control unit 27 deploys the image data to bit map on the memory 25. Then, the dot counter 28 measures the print dot density Δ according to data thus deployed with the following equation:

Print dot density Δ(%)=(dot number to be exposed/total pixel number in entire area)×100

In the embodiment, the dot density monitoring unit 31 monitors the print dot density Δ. When the print dot density Δ is less than 50, an instruction is sent to the power source control unit 30 through the DB-DS switch determining unit 32, so that the developing voltage DB is set at −100 V (DB=−100 V) and the absolute value of the difference DS is set at 150 V (DS=150 V) upon using the toner B and the developing roller β or the developing roller γ, i.e., the setting in sample 1 or sample 5. Further, the developing voltage DB is set at −100 V (DB=−100 V) and the absolute value of the difference DS is set at 150 V (DS=150 V) upon using the toner C and the developing roller β or the developing roller γ, i.e., the setting in sample 9 or sample 13.

An experiment was conducted for evaluating an entire density fluctuation. In the experiment, a half-tone image with the print dot density Δ of 25 (Δ=25%) was printed. In general, when the amount of the toner on the developing roller 4 increases, the amount of the toner transferred (moved) to the photosensitive drum 7 increases, thereby deteriorating toner reproducibility. When the toner scatters irregularly around a dot, the entire density fluctuation increases, or the half-tone image looks crashed (poor graininess).

In the experiment, image densities of the half-tone image were measured at three locations thereof, i.e., a center and both ends thereof, in the printing direction thereof. Then, a minimum value was divided by a maximum value to be a measurement value. When the measurement value was less than 0.20, the result was represented to be good. As a result of the experiment, it was found that a good image was obtained.

As described above, in the first embodiment, it is possible to obtain a good image even when the print dot density is high. In the second embodiment, through changing the developing voltage DB and the absolute value of the difference DS are changed according to the print dot density, it is possible to obtain a good image without lowering the through put regardless of the print dot density.

In the first and second embodiment, the present invention is applied to the printer, and is not limited thereto. The present invention is applicable to a facsimile, a copier, and the likes using the electro-photography method. Further, in the first and second embodiment, the conductive fine powder is formed of titanium oxide, and is not limited thereto. Further, the amount of the conductive fine powder, the charge amount of the toner, the surface roughness of the developing roller 4, the developing voltage DB, and the absolute value of the difference DS are just examples. Even when other values are adopted, as far as the developing efficiency is less than 0.60, it is possible to obtain the same effect.

In the embodiments described above, the present invention is applied to the printer, and is applicable to a copier, facsimile, a multi-function product, and the likes.

The disclosure of Japanese Patent Application No. 2008-138839, filed on May 28, 2008, is incorporated in the application by reference.

While the invention has been explained with reference to the specific embodiments of the invention, the explanation is illustrative and the invention is limited only by the appended claims.

What is claimed is:

1. A developing device comprising:
an image supporting member for supporting a static latent image; and
a developer supporting member for developing the static latent image formed on the image supporting member using developer so that a ratio of a maximum amount of the developer on the image supporting member per unit area with respect to an amount of the developer on the developer supporting member per unit area does not exceed 0.60.

2. An image forming apparatus comprising:
an image supporting member for supporting a static latent image; and
a developer supporting member for developing the static latent image formed on the image supporting member using developer so that a ratio of a maximum amount of the developer on the image supporting member per unit area with respect to an amount of the developer on the developer supporting member per unit area does not exceed 0.60.

3. The image forming apparatus according to claim 2, further comprising a developer supplying member for supplying the developer to the developer supporting member, said developer supplying member supplying the developer to the developer supporting member so that the ratio of the maximum amount of the developer on the image supporting member per unit area with respect to the amount of the developer on the developer supporting member per unit area is between 0.35 and 0.60.

4. The image forming apparatus according to claim 2, further comprising a developer supplying member for supplying the developer to the developer supporting member, said developer supplying member supplying the developer to the developer supporting member so that the amount of the developer on the developer supporting member is between 0.55 and 0.85.

5. The image forming apparatus according to claim 2, wherein said developer supplying member has a surface with a surface roughness thereby between 5.0 μm and 10.0 μm.

6. The image forming apparatus according to claim 2, where said developer supporting member is adopted to develop the static latent image using the developer containing a conductive fine powder with a weight part between 0.25 and 0.45, and having a charge amount with an absolute value between 30 μC/g and 50 μC/g.

7. The image forming apparatus according to claim 2, further comprising a developing power source for supplying a developing voltage to the developer supporting member, a developer supplying power source for supplying a developer supplying voltage to the developer supplying member, and a control unit for controlling the developing power source and the developer supplying power source, said developing power source supplying the developing voltage having an absolute value between 100 V and 200 V so that a difference between the developing voltage and the developer supplying voltage has an absolute value between 150 V and 200 V.

8. The image forming apparatus according to claim 7, further comprising an image density measurement unit for measuring an image density according to image data, said control unit controlling the developing power source and the developer supplying power source according to the image density.

9. A method of forming an image, comprising the steps of:
forming a static latent image on an image supporting member;
supplying developer to a developer supporting member; and
developing the static latent image on the image supporting member using the developer so that a ratio of a maximum amount of the developer on the image supporting member per unit area with respect to an amount of the developer on the developer supporting member per unit area does not exceed 0.60.

10. The method of forming an image according to claim 9, wherein, in the step of supplying the developer to the developer supporting member, said developer is supplies so that the ratio of the maximum amount of the developer on the image supporting member per unit area with respect to the amount of the developer on the developer supporting member per unit area is between 0.35 and 0.60.

11. The method of forming an image according to claim 9, wherein, in the step of supplying the developer to the developer supporting member, said developer is supplied to the developer supporting member so that the amount of the developer on the developer supporting member is between 0.55 and 0.85.

12. The method of forming an image according to claim 9, further comprising the steps of supplying a developing voltage to the developer supporting member; and supplying a developer supplying voltage to a developer supplying member, said developing voltage having an absolute value between 100 V and 200 V so that a difference between the developing voltage and the developer supplying voltage has an absolute value between 150 V and 200 V.

13. The method of forming an image according to claim 9, further comprising the steps of measuring an image density according to image data, and controlling the developing power source and the developer supplying power source according to the image density.
